(19) United States
(12) Patent Application Publication
(10) Pub. No.: US 2009/0191304 A1
(43) Pub. Date: Jul. 30, 2009

(54) MINERAL LICK

(76) Inventors: Haig H. Kassouni, Grand Rapids, MI (US); Armen S. Kassouni, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/021,618

(22) Filed: Jan. 29, 2008

(51) Int. Cl. A23K 1/20; B65D 81/26; A23L 1/304

(52) U.S. Cl. 426/1; 426/648; 426/106

(57) ABSTRACT

A process of attracting land animals and/or supplementing the diet of land animals with mineral nutrients involves selecting a location for attracting and/or supplementing the diet of the land animals and disposing at the selected location a compressed cohesive mass of mineral components that when consumed promotes health and/or growth, wherein the compressed cohesive mass of mineral components has a size, shape and mass that facilitates portability, ease of delivery to a selected location and avoidance of communal consumption that could promote the transmission of disease.

### FIELD OF THE INVENTION

This invention relates to the attraction of and dietary mineral supplements for land animals, especially land based wildlife and game. The term “land animals” is intended to include birds and fowl. The term “wildlife” as used herein refers to wild or game land animals.

### BACKGROUND OF THE INVENTION

It is generally believed that land animals, especially deer and other members of the family Cervidae, are attracted to salts and other mineral nutrients, and that mineral supplementation, especially of biovailable phosphorous and calcium, promotes or at least facilitates antler development in males and may be beneficial for lactating females, generally improving the health and strength of a herd. Hunters, wildlife photographers and other nature enthusiasts have used artificial salt or mineral licks to attract deer and other mammals belonging to the family Cervidae, and to promote the health of these animals.

Commercially available products for preparing an artificial salt or mineral lick for members of the family Cervidae have been limited to large bricks (e.g., 4 to 50 pound bricks having dimensions up to about 8 inches by 8 inches by 11 inches), and bagged powders.

Typically, the bricks are simply placed on the ground and allowed to slowly dissolve by exposure to humidity and precipitation. Bagged powders may be poured directly onto the ground, and optionally mixed into the soil, or dissolved and/or suspended in water that is subsequently poured onto the ground.

### SUMMARY OF THE INVENTION

In accordance with a certain aspect of the invention, there is provided a process of attracting and/or supplementing the diet of wildlife with mineral nutrients. The process comprises steps of selecting a location for attracting and/or supplementing the diet of ”, and disposing at a selected location a compressed cohesive mass of mineral components that when consumed by wildlife promotes the health and/or growth, the compressed cohesive mass of mineral components having a size, shape and mass facilitating portability, ease of delivery to the selected location, and avoidance of communal consumption that could promote the transmission of disease.

In accordance with a certain aspect of the invention, the dietary mineral supplement includes a compressed cohesive mass of mineral components having a size, shape and mass facilitating portability, ease of delivery to an application site, effective and efficient metering of an appropriate quantity of minerals to the application site, and avoidance of communal consumption that could promote the transmission of communicable disease.

These and other features, advantages and objects of the present invention will be further understood and appreciated by those skilled in the art by reference to the following specification and claims.

### DETAILED DESCRIPTION OF PREFERRED EMBODIMENTS

The expression “compressed cohesive mass” as used herein refers to a mass of solid material having a suitable hardness and a relatively low friability such that it will not easily break, disintegrate or otherwise breakdown during normal handling, so that it can be carried, such as in a person's pocket, to a site of application. The compressed cohesive mass of the invention is similar to a compressed pharmaceutical or nutritional tablet, except for its size, and may be prepared in a manner similar to the manner in which pharmaceutical and nutritional compressed tablet dosage forms are prepared.

The compressed cohesive mass of the invention may comprise or consist essentially of mineral components and optionally small amounts of other components. A compressed cohesive mass consisting essentially of mineral components refers to a compressed cohesive mass that contains either none or unsubstantial amounts of other nutritional materials (e.g., fats, proteins, and carbohydrates), but which may contain small amounts of additives such as colorants (e.g., food coloring), flavorants and/or scents (e.g., apple, corn or molasses), attractants (e.g., estrous/urine scent), and tablet excipients, such as binders (e.g., starch or starch derivatives), disintegrants (e.g., sodium starch glycolate), and lubricants (e.g., stearic acid). Unsubstantial amounts of other nutritional materials are amounts that constitute less than 10% of the mass of the compressed cohesive mass in the case of starches and starch derivatives or other materials used as binders and/or disintegrants, with only trace impurities of other nutritive ingredients, and about 2% or less of a lubricant based on the mass of the compressed cohesive mass. Desirably, the components are selected to provide an extremely long or indefinitely long shelf life. This is achieved by excluding or minimizing organic nutritional components.

The expression “mineral nutrients” and the expression “mineral components” refer to the source materials that provide biovailable mineral nutrients.

The antlers of members of the family Cervidae are typically composed of about 20% calcium and 10% phosphorous by mass. Accordingly, it is believed that the dietary needs of Cervidae species are best satisfied with a diet containing calcium and phosphorous in a mass ratio of about 2:1. Cervidae species also require sodium in their diet. A suitable compressed cohesive mass in accordance with the invention consists of mineral components that may contain from about 30% to about 50% sodium chloride, about 10% to about 20% calcium chloride, about 40% to about 50% dicalcium phosphate, and up to about about 2% of a tablet lubricant, and optional trace amounts of other mineral nutrients. A composition comprising or consisting essentially of mineral components and tabletting aids may contain sodium chloride, calcium chloride and dicalcium phosphate in the above proportions, with the percentages adjusted downwardly based on the addition of optional tabletting aids, and/or trace amounts of additives (e.g., colorants, flavorants, scents, attractants, etc.). Other mineral sources may be used rather than calcium chloride, dicalcium phosphate and sodium chloride, if desired. For example, other sources of calcium include calcium sulfate and calcium citrate. Other sources of phosphate include dibasic potassium phosphate and dibasic sodium phosphate (which is also an alternative source for sodium). Preferably, when such alternative mineral sources are used, they are employed in relative amounts to achieve an elemental calcium to phosphorous mass ratio of about 2:1, and preferably an elemental sodium to calcium mass ratio of from about 1:1 to about 1.5:1.

The compositions used to prepare the compressed cohesive mass of the invention may optionally contain trace amounts of other dietary mineral supplements to provide nutritive amounts of zinc, magnesium, sulfur, copper, iodine, cobalt and/or selenium. Suitable sources of these dietary supplements are well-known and include, for example, zinc ascorbate, zinc citrate, zinc malate, zinc succinate, magnesium ascorbate, magnesium aspartate, magnesium citrate, sodium sulfate, cupric oxide, copper gluconate, copper sulfate, potassium iodide, sodium iodide, cyanocobalamin, sodium selenate and sodium selenite. Suitable trace amounts of these dietary mineral supplements are known and can be selected, if desired, by reference to the literature. However, it is expected that the total amount of these trace mineral supplements will not exceed 1 or 2% by mass of compressed cohesive mass.

In addition to the mineral components, the compressed cohesive masses of this invention may contain conventional tabletting aids such as binders, disintegrants and lubricants.

Examples of binders that may be employed include microcrystalline cellulose, starch and starch derivatives. Such binders may be employed in generally any suitable amount, typically about 10% or less by mass to minimize the cost of the compressed cohesive mass and to minimize the amount of non-nutritive ingredients in the compressed cohesive mass. Examples of disintegrants that may optionally be employed, typically in relatively small amounts (such as about 5 % or less by mass), include starch and sodium starch glycolate. Suitable tabletting lubricants used to prevent material from sticking to dies and punches employed to prepare compressed cohesive masses from powders or granules include fatty acids, such as stearic acid, and metal salts of fatty acids, such as magnesium stearate, which may be used in an amount of, for example, from about 0.5% to about 2.5% by mass.

Colorants (e.g., food coloring), scents, flavorings and attractants (e.g., estrous/urine scent) may be added to the mineral components in relatively trace amounts (e.g., typically less than 1% by mass of each) prior to compressing the mineral components and optional tabletting aids into a cohesive mass.

The compressed cohesive mass of the invention can be prepared using a suitably sized and shaped die and punch with a hydraulic press capable of applying sufficient pressure to a powdered mass deposited between the die and punch to convert the powdered mass into a cohesive mass having suitable hardness and a suitably low friability to facilitate handling without breakage or loss of material. Suitable compression forces range from about 5,000 to about 10,000 psi.

An appropriate size and mass for the compressed cohesive mass in order to achieve ease of delivery to an application site, portability, effective and efficient metering of an appropriate quantity, and avoidance of communal consumption has a maximum or largest dimension of from about 0.5 inches to about 2.5 inches and a weight of from about 0.8 ounces to about ½ pound, preferably ¼ pound. Preferably, the compressed cohesive mass in accordance with the invention has a size, shape and mass that allows the compressed cohesive mass to be easily thrown, tossed, flung, or dropped, as desired, at a selected site of application. Objects much less than 0.5 inches in diameter and/or much less than about 0.8 ounces or much greater than about 2.5 inches in diameter or much more than about ½ pound in mass, cannot be easily thrown or tossed a great distance to a desired location, especially with a desired degree of accuracy. Further, objects much greater than 1 pound in mass and/or objects having a diameter much greater than about 2.5 inches cannot be easily carried in a person's pocket, and lack the desired degree of portability. Finally, a compressed cohesive mass of mineral components having a dimension much greater than 2.5 inches tends to allow more than one animal to lick the object and thus facilitates communal consumption and could promote transmission of diseases.

The compressed cohesive mass of mineral components in accordance with the invention can be formed into generally any shape. For example, briquette, cubic or rectangular shapes can be made. However, a preferred shape is a cylinder, disk or puck shape having a diameter of from about 0.5 inches to about 2.5 inches and a height of from about 0.5 inches to 2.5 inches, with a typical compressed cohesive mass of mineral components in accordance with the invention having a largest dimension of from about 1 inch to about 2 inches.

In accordance with certain other aspects of the invention, the compressed cohesive mass of mineral components may be color-coded based on recipe, or for camouflage effect if desired. The compressed cohesive mass of mineral components in accordance with the invention may also be used as a carried for other types of animal products, such as contraceptives or specialized vitamins.

Because certain mineral components may be hygroscopic, it may be desirable to pack the compressed cohesive mass or masses in accordance with the invention in a moisture resistant package (e.g., plastic container or wrap having a moisture barrier property).

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A dietary mineral supplement for land animals, comprising:
a compressed cohesive mass of mineral components that when consumed by land animals promotes the health and/or growth of the animal, the compressed form having a size, shape and mass facilitating portability, ease of delivery to an application site, effective and efficient metering of an appropriate quantity of minerals to the application site, and avoidance of communal consumption that could promote the transmission of disease.

2. The compressed mass of claim 1 having dimensions of from about 0.5 to about 2.5 inches.

3. A compressed mass of claim 2 shaped into a cylinder.

4. A compressed mass of claim 3 shaped into a briquette.

5. A compressed mass of claim 1 having a largest dimension of about 2.5 inches or less.

6. A compressed mass of claim 1 having a smallest dimension of about 0.5 inches or more.

7. A compressed mass of claim 1 having a weight of about 0.8 ounces or more.

8. A compressed mass of claim 1 having a weight of about ¼ pound or less.

9. A compressed mass of claim 1, wherein the mineral components include a source of sodium, calcium and phosphorous.

10. A compressed mass of claim 1, wherein the mineral components include sodium chloride, calcium chloride and dicalcium phosphate.

11. A compressed mass of claim 1, packed in a moisture resistant package.

12. The compressed mass of claim 1 which includes a scent, attractant, flavorant or a mixture of two or more thereof.

13. The compressed mass of claim 12 having dimensions of from about 0.5 to about 2.5 inches.

14. A compressed mass of claim 13 shaped into a cylinder.

15. A compressed mass of claim 13 shaped into a briquette.

16. A process of attracting and/or supplementing the diet of land animals with mineral nutrients, comprising steps of:
selecting a location for attracting and/or supplementing the diet of land animals.
disposing at the selected location a compressed cohesive mass of mineral components that when consumed promotes health and/or growth, the compressed cohesive mass of mineral components having a size, shape and mass facilitating portability, ease of delivery to the selected location and avoidance of communal consumption that could promote the transmission of disease.

17. A process of claim 16, wherein the step of disposing at the selected location a compressed cohesive mass of mineral components comprises throwing or tossing the compressed cohesive mass of mineral components to the selected location.

18. The process of claim 16 with the compressed cohesive mass having dimensions of from about 0.5 to about 2.5 inches

19. A process of claim 18, wherein the compressed cohesive mass is shaped into a cylinder.

20. A process of claim 18, wherein the compressed cohesive mass is shaped into a briquette.

21. A process of claim 16, wherein the compressed cohesive mass has a largest dimension of about 2.5 inches or less.

22. A process of claim 16, wherein the compressed cohesive mass has a largest dimension of about 0.5 inches or more.

23. A process of claim 16, wherein the compressed cohesive mass has a weight of about 0.8 ounces or more.

24. A process of claim 16, wherein the compressed cohesive mass has a weight of about ¼ pound or less.

25. A process of claim 16, wherein the mineral components include a source of sodium, calcium and phosphorous.

26. A process of claim 16, wherein the mineral components include sodium chloride, calcium chloride and dicalcium phosphate.

27. The process of claim 16 in which the compressed mass includes a scent, attractant, flavorant or a mixture of two or more thereof.

28. The process of claim 27 in which the compressed mass has dimensions of from about 0.5 to about 2.5 inches.

29. The process of claim 28 in which the compressed mass is shaped into a cylinder.

30. The process of claim 28 in which the compressed mass is shaped into a briquette.
